(19) United States
(12) Patent Application Publication
(10) Pub. No.: US 2023/0150151 A1
(43) Pub. Date: May 18, 2023

(54) End of Arm Sensing Device

(71) Applicant: X Development LLC, Mountain View, CA (US)

(72) Inventors: Eden Rephaeli, Oakland, CA (US); Marc Strauss, Fremont, CA (US); Guy Satat, Sunnyvale, CA (US)

(21) Appl. No.: 18/053,739

(22) Filed: Nov. 8, 2022

Related U.S. Application Data
(60) Provisional application No. 63/263,850, filed on Nov. 10, 2021.

(51) Int. Cl. B25J 19/02; B25J 5/00; B25J 18/00

(52) U.S. Cl. CPC B25J 19/021; B25J 5/007; B25J 18/00

(57) ABSTRACT

A sensing device is described for mounting on a movable component of a robotic device. The sensing device includes a plurality of illumination sources comprising at least one ultraviolet (UV) illumination source. The sensing device further includes at least two cameras arranged in a stereo pair. The sensing device additionally includes a camera with a UV filter, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range.

### CROSS-REFERENCE TO RELATED APPLICATIONS

This application claims priority to U.S. Provisional Pat. Application No. 63/263,850, filed Nov. 10, 2021, the disclosure of which is incorporated by reference herein in its entirety.

### BACKGROUND

As technology advances, various types of robotic devices are being created for performing a variety of functions that may assist users. Robotic devices may be used for applications involving material handling, transportation, welding, assembly, and dispensing, among others. Over time, the manner in which these robotic systems operate is becoming more intelligent, efficient, and intuitive. As robotic systems become increasingly prevalent in numerous aspects of modern life, it is desirable for robotic systems to be efficient. Therefore, a demand for efficient robotic systems has helped open up a field of innovation in actuators, movement, sensing techniques, as well as component design and assembly.

### SUMMARY

Example embodiments involve specialized sensing systems on a robotic device. A robotic device may be equipped with a sensing device mounted on a moveable component of the robotic device, and the sensing device may include illumination sources, cameras, and a camera with an ultraviolet (UV) filter. The UV filter may allow wavelengths corresponding to UV light and block wavelengths corresponding to visible and near infrared light. The robotic device may control the sensing device and collect sensor data using the sensing device.

In an embodiment, a sensing device is described for mounting on a movable component of a robotic device, wherein the sensing device includes a plurality of illumination sources comprising at least one ultraviolet (UV) illumination source. The sensing device also includes at least two cameras arranged in a stereo pair. The sensing device additionally includes a camera with a UV filter, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range.

In another embodiment, a robotic device includes a movable component. The robotic device also includes a sensing device mounted on the movable component, wherein the sensing device includes a plurality of illumination sources comprising at least one ultraviolet (UV) illumination source. The sensing device additionally includes at least two cameras arranged in a stereo pair. The sensing device also includes a camera with a UV filter, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range.

In another embodiment, a method includes controlling a moveable component of the robotic device, wherein a sensing device is mounted to the moveable component of the robotic device, wherein the sensing device comprises a plurality of illumination sources, at least two cameras arranged in a stereo pair, and a camera with a UV filter. The method additionally includes receiving, from the at least two cameras, stereo camera data indicative of a surface. The method also includes receiving, from the camera with the UV filter, UV camera data of the surface, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range. The method further includes determining, based on the stereo camera data and the UV camera data, one or more properties of the surface.

In a further embodiment, a non-transitory computer readable medium is provided which includes programming instructions executable by at least one processor to cause the at least one processor to perform functions. The functions include controlling a moveable component of the robotic device, wherein a sensing device is mounted to the moveable component of the robotic device, wherein the sensing device comprises a plurality of illumination sources, at least two cameras arranged in a stereo pair, and a camera with a UV filter. The functions additionally include receiving, from the at least two cameras, stereo camera data indicative of a surface. The functions also include receiving, from the camera with the UV filter, UV camera data of the surface, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range. The functions further include determining, based on the stereo camera data and the UV camera data, one or more properties of the surface.

In another embodiment, a system is provided that includes means for controlling a moveable component of the robotic device, wherein a sensing device is mounted to the moveable component of the robotic device, wherein the sensing device comprises a plurality of illumination sources, at least two cameras arranged in a stereo pair, and a camera with a UV filter. The system additionally includes means for receiving, from the at least two cameras, stereo camera data indicative of a surface. The system also includes means for receiving, from the camera with the UV filter, UV camera data of the surface, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range. The system also includes means for determining, based on the stereo camera data and the UV camera data, one or more properties of the surface.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates a configuration of a robotic system, in accordance with example embodiments.

FIG. 2 illustrates a mobile robot, in accordance with example embodiments.

FIG. 3 illustrates an exploded view of a mobile robot, in accordance with example embodiments.

FIG. 4 illustrates a robotic arm, in accordance with example embodiments.

FIG. 5A depicts a sensing device, in accordance with example embodiments.

FIG. 5B depicts components of a sensing device, in accordance with example embodiments.

FIG. 5C depicts components of a sensing device, in accordance with example embodiments.

FIG. 6 is a sensor arrangement on an end of arm system, in accordance with example embodiments.

FIG. 7 is a plot of transmitted light through an ultraviolet (UV) filter, in accordance with example embodiments.

FIG. 8 depicts fields of views of components on the sensor arrangement, in accordance with example embodiments.

FIG. 9 illustrates images taken with a sensor arrangement, in accordance with example embodiments.

FIG. 10A depicts an exposure schedule, in accordance with example embodiments.

FIG. 10B depicts an exposure schedule, in accordance with example embodiments.

FIG. 10C depicts an exposure schedule, in accordance with example embodiments.

FIG. 11 is a block diagram of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

A robotic device may be used for a variety of applications to streamline processes, such as material handling, transportation, assembly, and manufacturing. For some applications, a robotic device may need to detect various materials and/or substances on a surface. For example, the robotic device may be cleaning a cafeteria and may need to detect the various substances present on cafeteria tables and/or cafeteria floors to determine an amount and/or type of detergent to be used.

In some examples, detecting various materials and/or substances on a surface may be hindered by poor visibility of a material and/or substance on the surface. More specifically, a robotic device may collect data using a camera capable of capturing light in the visible spectrum (e.g., wavelengths of light that correspond to visible light), but overlapping substances and/or materials may be indistinguishable if a substance and/or material is the same color as its surroundings and/or is transparent. For example, black coffee and water spilled separately on a brown table may be indistinguishable from the brown table in visible light images. A robotic device may also capture sensor data using a UV camera capable of capturing light in the UV spectrum, but some substances and/or materials may likewise be indistinguishable in this UV camera sensor data.

Proposed herein are sensing devices capable of collecting data in both the visible spectrum and the UV spectrum. These sensing devices may be used in a variety of applications where having data in both spectrums may facilitate completing a task. For example, a robotic device may be tasked with cleaning a surface. The sensing device proposed herein may collect data representative of the surface in both the visible and the UV spectrum to better determine which substances are on the surface. As another example, a robotic device may be used in medical applications, and obtaining sensor data in both the visible and UV spectrum may facilitate determining and identifying various medical conditions, e.g., skin conditions.

An example sensing device may include illumination sources, at least two cameras arranged in a stereo pair, and a camera with a UV filter. The illumination sources may include at least one UV illumination source. The UV filter may be configured to allow wavelengths that correspond to UV light and block wavelengths that correspond to visible and near infrared light. In some examples, the cameras may be arranged in a v-shaped cluster, and the illumination sources may surround the v-shaped cluster of cameras. In some examples, the illumination sources may include a white light emitting diode (LED) cluster and two UV LED clusters. The white LED cluster may include four white LEDs and the two UV LED clusters may include a total of six UV LEDs. In some examples, the two cameras arranged in the stereo pair and the two UV LED clusters may be arranged symmetrically with respect to a plane running through the optical axis of the camera with the UV filter and the central axis of the white LED cluster.

This arrangement may facilitate overlap between fields of view of the cameras and the illumination sources such that sensor data collected using this arrangement may be consistently illuminated with the illumination sources.

In some examples, the sensing device may be mounted to a moveable component of the robotic device. For example, the moveable component of the robotic device may be an end of arm system. The end of arm system may include a gripper, and the sensing device may be mounted adjacent to the gripper such that the gripper is within the field of view of at least one camera. The robotic device may then use the sensing device to determine whether the gripper is grasping an object and/or properties of the object (e.g., size, length, etc.).

In some examples, the sensing device may include multiple stackable printed circuit boards (PCBs) such that the illumination sources and the cameras are mounted on different circuit boards. Namely, an illumination subsystem may include illumination sources mounted on a first PCB in a first printed circuit board assembly (PCBA), and an imaging subsystem may include cameras, each mounted on a different PCB. The imaging subsystem may include a main imaging PCBA, which may be connected to at least one logic board, which may then be connected to at least one flex extension, which may then be connected to each of the cameras. The illumination subsystem may be mounted on top of the imaging subsystem. This approach may facilitate easier manufacturing and repair, because each PCBA and other components may be manufactured and replaced separately. In some examples, each camera module may be manufactured and pre-focused separately as well (e.g., to focus on particular ranges). In some examples, the first PCBA and/or the second PCBA may include an inertial measurement unit (IMU). The IMU may be used to detect the orientation of the sensing device and/or of the moveable component, among other possibilities.

In some examples, the sensing device may also include a fan in proximity to the sensors on the sensing device. This fan may cool the sensing device by drawing hot air generated by the components on the PCBAs (e.g., from the illumination sources, sensors, and/or the processors of the sensing device) out of the sensing device. The fan may direct air over the surfaces of the heat-generating components within the sensing device and then away from the sensing device.

In some examples, each camera that is not covered by a UV filter may be covered by a near infrared block filter or lens-coating that blocks wavelengths corresponding to near infrared light. By using filters to block near infrared light, the cameras may reduce the amount of interference of light outside the desired range (e.g., wavelengths corresponding to visible light) in the collected sensor data.

In some examples, the cameras may have a negative distortion. The negative distortion may result in a larger portion of the environment being detected in the sensor data. Adjustments may be made for the distortion after the sensor data has been collected.

Other arrangements of the sensing device and other components to be included on the sensing device may be possible. For example, the at least two cameras arranged in a stereo pair may comprise three cameras arranged in a stereo arrangement. In some examples, the sensing device may include a stereo pair of cameras, each having a UV filter. Additionally or alternatively, the sensing device may include other illumination sources (e.g., red blue green LED clusters) in lieu of the UV LEDs clusters and/or the white LEDs clusters.

In some examples, one or more processors of the robotic device may carry out a method involving the moveable component of the robotic device and the sensing device that may be mounted to the moveable component of the robotic device. Namely, the robotic device may control the moveable component, perhaps to move closer to a surface such that the sensing device is facing the surface. The robotic device may then receive stereo camera data indicative of the surface from the at least two cameras arranged as a stereo pair on the sensing device. The robotic device may also receive UV camera data indicative of the surface from the camera with the UV filter on the sensing device. Based on the stereo camera data, the robotic device may determine one or more properties of the surface. Further example methods may involve an automatic gain control algorithm as well or instead. An automatic gain control algorithm may involve automatic adjustment of one or more parameters such as LED brightness, on time, and/or camera exposure time for the white illuminator(s) and/or visible-spectrum camera(s) and/or the UV illuminator(s) and/or UV camera(s).

In some examples, illumination from other sources on the robotic device may interfere with sensor data collected by the sensing device, and illumination from the sensing device may interfere with sensor data collected by other sensing systems on the robotic device. The illumination sources of each part of the robotic device may thus be enabled and disabled periodically to correspond to which sensor data is being collected.

For example, the robotic device may include another perception system that includes perception system illumination sources. Before receiving sensor data from this perception system, the robotic device may disable the illumination sources on the sensing device of the robotic device to avoid illumination cross-talk. Additionally, the robotic device may disable any perception system illumination sources before receiving sensor data from the sensing device on the robotic device. In some examples, the robotic device may disable only the UV illumination sources of the sensing device (leaving the visible light illumination sources enabled) before receiving perception system sensor data to avoid contamination from the UV light source.

To avoid illumination cross-talk, the robotic device may also enable and disable specific illumination sources on the sensing device to correspond to when the respective cameras collect data. For example, to avoid visible light contamination while collecting UV camera data, the robotic device may disable any visible illumination sources (e.g., white LED clusters) before collecting data using the camera with the UV sensor. Additionally or alternatively, to avoid UV light contamination, the robotic device may disable any UV illumination sources (e.g., UV LED clusters) before collecting data using the at least two cameras arranged in a stereo pair.

In some examples, the enabling and disabling of illumination sources and/or cameras on the sensing device may be periodic. For example, the UV illumination sources, the visible light illumination sources, the at least two cameras of the stereo pair, and the camera with the UV filter of the sensing device may each be enabled every fifty milliseconds for twenty milliseconds. Enabling the UV illumination sources and the camera with the UV filter may be delayed by twenty-five milliseconds from the enabling of the visible light illumination sources and the at least two cameras arranged in the stereo pair so that there is no cross-talk between the different types of illumination sources and the different types of sensor data that are being collected.

### II. Example Robotic Systems

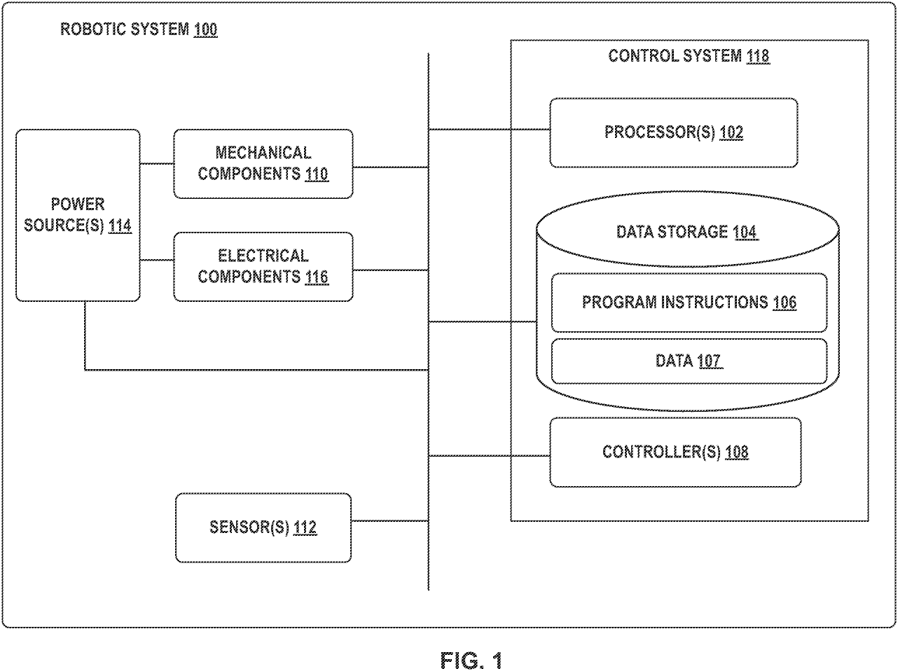

FIG. 1 illustrates an example configuration of a robotic system that may be used in connection with the implementations described herein. Robotic system 100 may be configured to operate autonomously, semi-autonomously, or using directions provided by user(s). Robotic system 100 may be implemented in various forms, such as a robotic arm, industrial robot, or some other arrangement. Some example implementations involve a robotic system 100 engineered to be low cost at scale and designed to support a variety of tasks. Robotic system 100 may be designed to be capable of operating around people. Robotic system 100 may also be optimized for machine learning. Throughout this description, robotic system 100 may also be referred to as a robot, robotic device, or mobile robot, among other designations.

As shown in FIG. 1, robotic system 100 may include processor(s) 102, data storage 104, and controller(s) 108, which together may be part of control system 118. Robotic system 100 may also include sensor(s) 112, power source(s) 114, mechanical components 110, and electrical components 116. Nonetheless, robotic system 100 is shown for illustrative purposes, and may include more or fewer components. The various components of robotic system 100 may be connected in any manner, including wired or wireless connections. Further, in some examples, components of robotic system 100 may be distributed among multiple physical entities rather than a single physical entity. Other example illustrations of robotic system 100 may exist as well.

Processor(s) 102 may operate as one or more general-purpose hardware processors or special purpose hardware processors (e.g., digital signal processors, application specific integrated circuits, etc.). Processor(s) 102 may be configured to execute computer-readable program instructions 106, and manipulate data 107, both of which are stored in data storage 104. Processor(s) 102 may also directly or indirectly interact with other components of robotic system 100, such as sensor(s) 112, power source(s) 114, mechanical components 110, or electrical components 116.

Data storage 104 may be one or more types of hardware memory. For example, data storage 104 may include or take the form of one or more computer-readable storage media that can be read or accessed by processor(s) 102. The one or more computer-readable storage media can include volatile or non-volatile storage components, such as optical, magnetic, organic, or another type of memory or storage, which can be integrated in whole or in part with processor(s) 102. In some implementations, data storage 104 can be a single physical device. In other implementations, data storage 104 can be implemented using two or more physical devices, which may communicate with one another via wired or wireless communication. As noted previously, data storage 104 may include the computer-readable program instructions 106 and data 107. Data 107 may be any type of data, such as configuration data, sensor data, or diagnostic data, among other possibilities.

Controller 108 may include one or more electrical circuits, units of digital logic, computer chips, or microprocessors that are configured to (perhaps among other tasks), interface between any combination of mechanical components 110, sensor(s) 112, power source(s) 114, electrical components 116, control system 118, or a user of robotic system 100. In some implementations, controller 108 may be a purpose-built embedded device for performing specific operations with one or more subsystems of the robotic system 100.

Control system 118 may monitor and physically change the operating conditions of robotic system 100. In doing so, control system 118 may serve as a link between portions of robotic system 100, such as between mechanical components 110 or electrical components 116. In some instances, control system 118 may serve as an interface between robotic system 100 and another computing device. Further, control system 118 may serve as an interface between robotic system 100 and a user. In some instances, control system 118 may include various components for communicating with robotic system 100, including a joystick, buttons, or ports, etc. The example interfaces and communications noted above may be implemented via a wired or wireless connection, or both. Control system 118 may perform other operations for robotic system 100 as well.

During operation, control system 118 may communicate with other systems of robotic system 100 via wired or wireless connections, and may further be configured to communicate with one or more users of the robot. As one possible illustration, control system 118 may receive an input (e.g., from a user or from another robot) indicating an instruction to perform a requested task, such as to pick up and move an object from one location to another location. Based on this input, control system 118 may perform operations to cause the robotic system 100 to make a sequence of movements to perform the requested task. As another illustration, a control system may receive an input indicating an instruction to move to a requested location. In response, control system 118 (perhaps with the assistance of other components or systems) may determine a direction and speed to move robotic system 100 through an environment en route to the requested location.

Operations of control system 118 may be carried out by processor(s) 102. Alternatively, these operations may be carried out by controller(s) 108, or a combination of processor(s) 102 and controller(s) 108. In some implementations, control system 118 may partially or wholly reside on a device other than robotic system 100, and therefore may at least in part control robotic system 100 remotely.

Mechanical components 110 represent hardware of robotic system 100 that may enable robotic system 100 to perform physical operations. As a few examples, robotic system 100 may include one or more physical members, such as an arm, an end effector, a head, a neck, a torso, a base, and wheels. The physical members or other parts of robotic system 100 may further include actuators arranged to move the physical members in relation to one another. Robotic system 100 may also include one or more structured bodies for housing control system 118 or other components, and may further include other types of mechanical components. The particular mechanical components 110 used in a given robot may vary based on the design of the robot, and may also be based on the operations or tasks the robot may be configured to perform.

In some examples, mechanical components 110 may include one or more removable components. Robotic system 100 may be configured to add or remove such removable components, which may involve assistance from a user or another robot. For example, robotic system 100 may be configured with removable end effectors or digits that can be replaced or changed as needed or desired. In some implementations, robotic system 100 may include one or more removable or replaceable battery units, control systems, power systems, bumpers, or sensors. Other types of removable components may be included within some implementations.

Robotic system 100 may include sensor(s) 112 arranged to sense aspects of robotic system 100. Sensor(s) 112 may include one or more force sensors, torque sensors, velocity sensors, acceleration sensors, position sensors, proximity sensors, motion sensors, location sensors, load sensors, temperature sensors, touch sensors, depth sensors, ultrasonic range sensors, infrared sensors, object sensors, or cameras, among other possibilities. Within some examples, robotic system 100 may be configured to receive sensor data from sensors that are physically separated from the robot (e.g., sensors that are positioned on other robots or located within the environment in which the robot is operating).

Sensor(s) 112 may provide sensor data to processor(s) 102 (perhaps by way of data 107) to allow for interaction of robotic system 100 with its environment, as well as monitoring of the operation of robotic system 100. The sensor data may be used in evaluation of various factors for activation, movement, and deactivation of mechanical components 110 and electrical components 116 by control system 118. For example, sensor(s) 112 may capture data corresponding to the terrain of the environment or location of nearby objects, which may assist with environment recognition and navigation.

In some examples, sensor(s) 112 may include RADAR (e.g., for long-range object detection, distance determination, or speed determination), LIDAR (e.g., for short-range object detection, distance determination, or speed determination), SONAR (e.g., for underwater object detection, distance determination, or speed determination), VICON® (e.g., for motion capture), one or more cameras (e.g., stereoscopic cameras for 3D vision), a global positioning system (GPS) transceiver, or other sensors for capturing information of the environment in which robotic system 100 is operating. Sensor(s) 112 may monitor the environment in real time, and detect obstacles, elements of the terrain, weather conditions, temperature, or other aspects of the environment. In another example, sensor(s) 112 may capture data corresponding to one or more characteristics of a target or identified object, such as a size, shape, profile, structure, or orientation of the object.

Further, robotic system 100 may include sensor(s) 112 configured to receive information indicative of the state of robotic system 100, including sensor(s) 112 that may monitor the state of the various components of robotic system 100. Sensor(s) 112 may measure activity of systems of robotic system 100 and receive information based on the operation of the various features of robotic system 100, such as the operation of an extendable arm, an end effector, or other mechanical or electrical features of robotic system 100. The data provided by sensor(s) 112 may enable control system 118 to determine errors in operation as well as monitor overall operation of components of robotic system 100.

As an example, robotic system 100 may use force/torque sensors to measure load on various components of robotic system 100. In some implementations, robotic system 100 may include one or more force/torque sensors on an arm or end effector to measure the load on the actuators that move one or more members of the arm or end effector. In some examples, the robotic system 100 may include a force/torque sensor at or near the wrist or end effector, but not at or near other joints of a robotic arm. In further examples, robotic system 100 may use one or more position sensors to sense the position of the actuators of the robotic system. For instance, such position sensors may sense states of extension, retraction, positioning, or rotation of the actuators on an arm or end effector.

As another example, sensor(s) 112 may include one or more velocity or acceleration sensors. For instance, sensor(s) 112 may include an IMU. The IMU may sense velocity and acceleration in the world frame, with respect to the gravity vector. The velocity and acceleration sensed by the IMU may then be translated to that of robotic system 100 based on the location of the IMU in robotic system 100 and the kinematics of robotic system 100.

Robotic system 100 may include other types of sensors not explicitly discussed herein. Additionally or alternatively, the robotic system may use particular sensors for purposes not enumerated herein.

Robotic system 100 may also include one or more power source(s) 114 configured to supply power to various components of robotic system 100. Among other possible power systems, robotic system 100 may include a hydraulic system, electrical system, batteries, or other types of power systems. As an example illustration, robotic system 100 may include one or more batteries configured to provide charge to components of robotic system 100. Some of mechanical components 110 or electrical components 116 may each connect to a different power source, may be powered by the same power source, or be powered by multiple power sources.

Any type of power source may be used to power robotic system 100, such as electrical power or a gasoline engine. Additionally or alternatively, robotic system 100 may include a hydraulic system configured to provide power to mechanical components 110 using fluid power. Components of robotic system 100 may operate based on hydraulic fluid being transmitted throughout the hydraulic system to various hydraulic motors and hydraulic cylinders, for example. The hydraulic system may transfer hydraulic power by way of pressurized hydraulic fluid through tubes, flexible hoses, or other links between components of robotic system 100. Power source(s) 114 may charge using various types of charging, such as wired connections to an outside power source, wireless charging, combustion, or other examples.

Electrical components 116 may include various mechanisms capable of processing, transferring, or providing electrical charge or electric signals. Among possible examples, electrical components 116 may include electrical wires, circuitry, or wireless communication transmitters and receivers to enable operations of robotic system 100. Electrical components 116 may interwork with mechanical components 110 to enable robotic system 100 to perform various operations. Electrical components 116 may be configured to provide power from power source(s) 114 to the various mechanical components 110, for example. Further, robotic system 100 may include electric motors. Other examples of electrical components 116 may exist as well.

Robotic system 100 may include a body, which may connect to or house appendages and components of the robotic system. As such, the structure of the body may vary within examples and may further depend on particular operations that a given robot may have been designed to perform. For example, a robot developed to carry heavy loads may have a wide body that enables placement of the load. Similarly, a robot designed to operate in tight spaces may have a relatively tall, narrow body. Further, the body or the other components may be developed using various types of materials, such as metals or plastics. Within other examples, a robot may have a body with a different structure or made of various types of materials.

The body or the other components may include or carry sensor(s) 112. These sensors may be positioned in various locations on the robotic system 100, such as on a body, a head, a neck, a base, a torso, an arm, or an end effector, among other examples.

Robotic system 100 may be configured to carry a load, such as a type of cargo that is to be transported. In some examples, the load may be placed by the robotic system 100 into a bin or other container attached to the robotic system 100. The load may also represent external batteries or other types of power sources (e.g., solar panels) that the robotic system 100 may utilize. Carrying the load represents one example use for which the robotic system 100 may be configured, but the robotic system 100 may be configured to perform other operations as well.

As noted above, robotic system 100 may include various types of appendages, wheels, end effectors, gripping devices and so on. In some examples, robotic system 100 may include a mobile base with wheels, treads, or some other form of locomotion. Additionally, robotic system 100 may include a robotic arm or some other form of robotic manipulator. In the case of a mobile base, the base may be considered as one of mechanical components 110 and may include wheels, powered by one or more of actuators, which allow for mobility of a robotic arm in addition to the rest of the body.

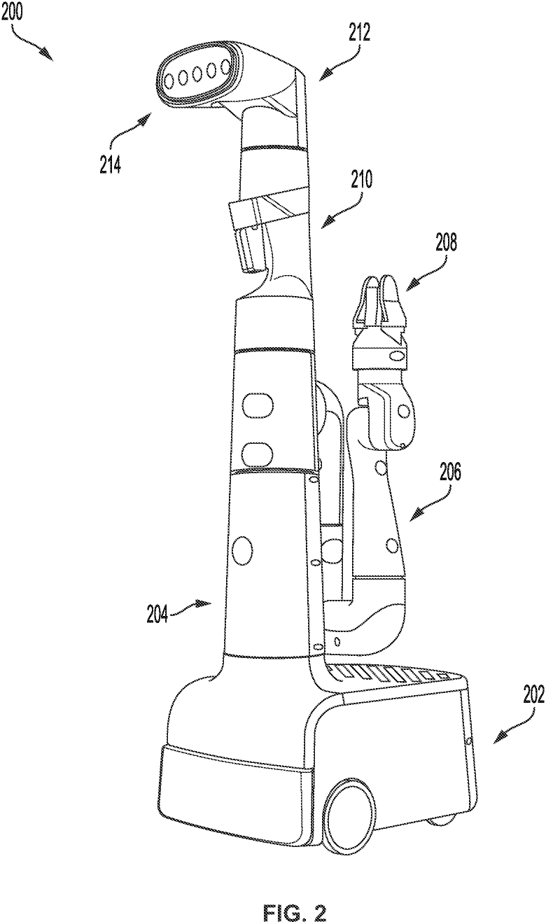

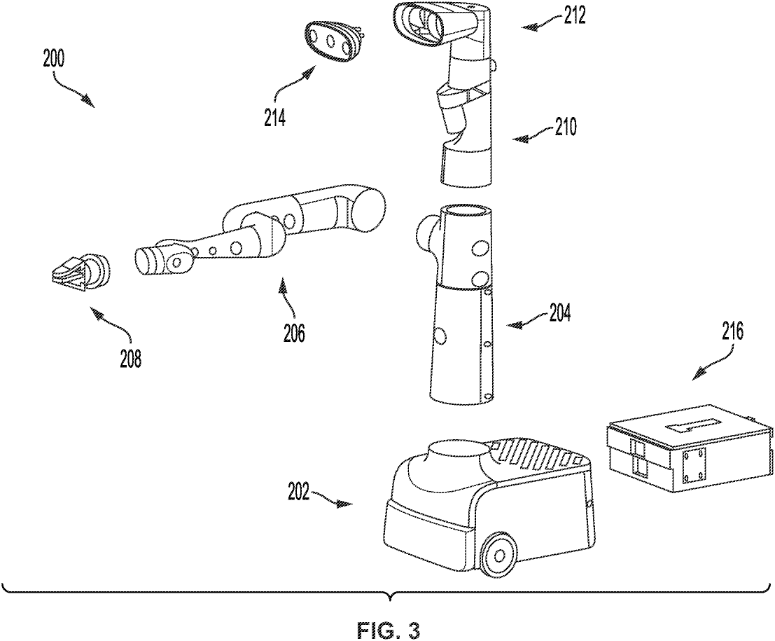

FIG. 2 illustrates a mobile robot, in accordance with example embodiments. FIG. 3 illustrates an exploded view of the mobile robot, in accordance with example embodiments. More specifically, a robot 200 may include a mobile base 202, a midsection 204, an arm 206, an end-of-arm system (EOAS) 208, a mast 210, a perception housing 212, and a perception suite 214. The robot 200 may also include a compute box 216 stored within mobile base 202.

The mobile base 202 includes two drive wheels positioned at a front end of the robot 200 in order to provide locomotion to robot 200. The mobile base 202 also includes additional casters (not shown) to facilitate motion of the mobile base 202 over a ground surface. The mobile base 202 may have a modular architecture that allows compute box 216 to be easily removed. Compute box 216 may serve as a removable control system for robot 200 (rather than a mechanically integrated control system). After removing external shells, the compute box 216 can be easily removed and/or replaced. The mobile base 202 may also be designed to allow for additional modularity. For example, the mobile base 202 may also be designed so that a power system, a battery, and/or external bumpers can all be easily removed and/or replaced.

The midsection 204 may be attached to the mobile base 202 at a front end of the mobile base 202. The midsection 204 includes a mounting column which is fixed to the mobile base 202. The midsection 204 additionally includes a rotational joint for arm 206. More specifically, the midsection 204 includes the first two degrees of freedom for arm 206 (a shoulder yaw J0 joint and a shoulder pitch J1 joint). The mounting column and the shoulder yaw J0 joint may form a portion of a stacked tower at the front of mobile base 202. The mounting column and the shoulder yaw J0 joint may be coaxial. The length of the mounting column of midsection 204 may be chosen to provide the arm 206 with sufficient height to perform manipulation tasks at commonly encountered height levels (e.g., coffee table top and counter top levels). The length of the mounting column of midsection 204 may also allow the shoulder pitch J1 joint to rotate the arm 206 over the mobile base 202 without contacting the mobile base 202.

The arm 206 may be a 7DOF robotic arm when connected to the midsection 204. As noted, the first two DOFs of the arm 206 may be included in the midsection 204. The remaining five DOFs may be included in a standalone section of the arm 206 as illustrated in FIGS. 2 and 3. The arm 206 may be made up of plastic monolithic link structures. Inside the arm 206 may be housed standalone actuator modules, local motor drivers, and thru bore cabling.

The EOAS 208 may be an end effector at the end of arm 206. EOAS 208 may allow the robot 200 to manipulate objects in the environment. As shown in FIGS. 2 and 3, EOAS 208 may be a gripper, such as an underactuated pinch gripper. The gripper may include one or more contact sensors such as force/torque sensors and/or non-contact sensors such as one or more cameras to facilitate object detection and gripper control. EOAS 208 may also be a different type of gripper such as a suction gripper or a different type of tool such as a drill or a brush. EOAS 208 may also be swappable or include swappable components such as gripper digits.

The mast 210 may be a relatively long, narrow component between the shoulder yaw J0 joint for arm 206 and perception housing 212. The mast 210 may be part of the stacked tower at the front of mobile base 202. The mast 210 may be fixed relative to the mobile base 202. The mast 210 may be coaxial with the midsection 204. The length of the mast 210 may facilitate perception by perception suite 214 of objects being manipulated by EOAS 208. The mast 210 may have a length such that when the shoulder pitch J1 joint is rotated vertical up, a topmost point of a bicep of the arm 206 is approximately aligned with a top of the mast 210. The length of the mast 210 may then be sufficient to prevent a collision between the perception housing 212 and the arm 206 when the shoulder pitch J1 joint is rotated vertical up.

As shown in FIGS. 2 and 3, the mast 210 may include a 3D lidar sensor configured to collect depth information about the environment. The 3D lidar sensor may be coupled to a carved-out portion of the mast 210 and fixed at a downward angle. The lidar position may be optimized for localization, navigation, and for front cliff detection.

The perception housing 212 may include at least one sensor making up perception suite 214. The perception housing 212 may be connected to a pan/tilt control to allow for reorienting of the perception housing 212 (e.g., to view objects being manipulated by EOAS 208). The perception housing 212 may be a part of the stacked tower fixed to the mobile base 202. A rear portion of the perception housing 212 may be coaxial with the mast 210.

The perception suite 214 may include a suite of sensors configured to collect sensor data representative of the environment of the robot 200. The perception suite 214 may include an infrared(IR)-assisted stereo depth sensor. The perception suite 214 may additionally include a wide-angled red-green-blue (RGB) camera for human-robot interaction and context information. The perception suite 214 may additionally include a high resolution RGB camera for object classification. A face light ring surrounding the perception suite 214 may also be included for improved human-robot interaction and scene illumination. In some examples, the perception suite 214 may also include a projector configured to project images and/or video into the environment.

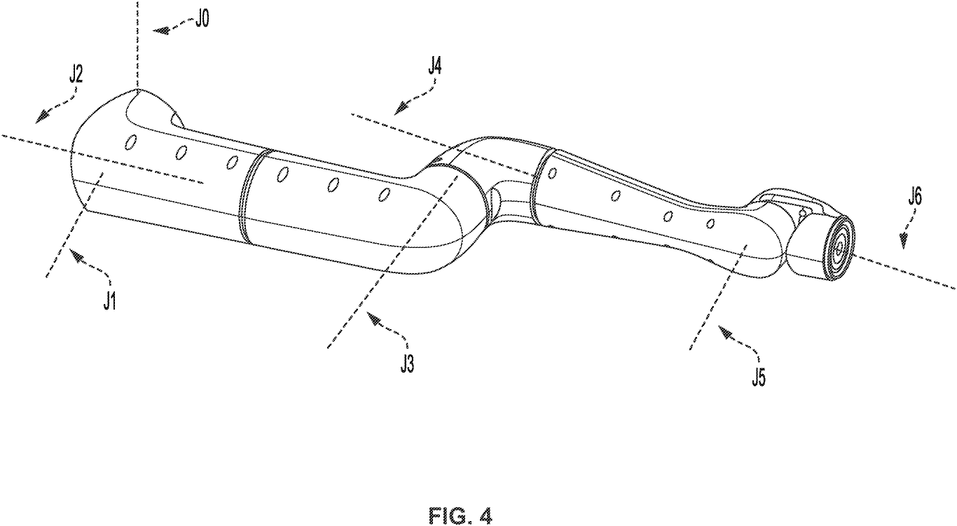

FIG. 4 illustrates a robotic arm, in accordance with example embodiments. The robotic arm includes 7 DOFs: a shoulder yaw J0 joint, a shoulder pitch J1 joint, a bicep roll J2 joint, an elbow pitch J3 joint, a forearm roll J4 joint, a wrist pitch J5 joint, and wrist roll J6 joint. Each of the joints may be coupled to one or more actuators. The actuators coupled to the joints may be operable to cause movement of links down the kinematic chain (as well as any end effector attached to the robot arm).

The shoulder yaw J0 joint allows the robot arm to rotate toward the front and toward the back of the robot. One beneficial use of this motion is to allow the robot to pick up an object in front of the robot and quickly place the object on the rear section of the robot (as well as the reverse motion). Another beneficial use of this motion is to quickly move the robot arm from a stowed configuration behind the robot to an active position in front of the robot (as well as the reverse motion).

The shoulder pitch J1 joint allows the robot to lift the robot arm (e.g., so that the bicep is up to perception suite level on the robot) and to lower the robot arm (e.g., so that the bicep is just above the mobile base). This motion is beneficial to allow the robot to efficiently perform manipulation operations (e.g., top grasps and side grasps) at different target height levels in the environment. For instance, the shoulder pitch J1 joint may be rotated to a vertical up position to allow the robot to easily manipulate objects on a table in the environment. The shoulder pitch J1 joint may be rotated to a vertical down position to allow the robot to easily manipulate objects on a ground surface in the environment.

The bicep roll J2 joint allows the robot to rotate the bicep to move the elbow and forearm relative to the bicep. This motion may be particularly beneficial for facilitating a clear view of the EOAS by the robot’s perception suite. By rotating the bicep roll J2 joint, the robot may kick out the elbow and forearm to improve line of sight to an object held in a gripper of the robot.

Moving down the kinematic chain, alternating pitch and roll joints (a shoulder pitch J1 joint, a bicep roll J2 joint, an elbow pitch J3 joint, a forearm roll J4 joint, a wrist pitch J5 joint, and wrist roll J6 joint) are provided to improve the manipulability of the robotic arm. The axes of the wrist pitch J5 joint, the wrist roll J6 joint, and the forearm roll J4 joint are intersecting for reduced arm motion to reorient objects. The wrist roll J6 point is provided instead of two pitch joints in the wrist in order to improve object rotation.

In some examples, a robotic arm such as the one illustrated in FIG. 4 may be capable of operating in a teach mode. In particular, teach mode may be an operating mode of the robotic arm that allows a user to physically interact with and guide robotic arm towards carrying out and recording various movements. In a teaching mode, an external force is applied (e.g., by the user) to the robotic arm based on a teaching input that is intended to teach the robot regarding how to carry out a specific task. The robotic arm may thus obtain data regarding how to carry out the specific task based on instructions and guidance from the user. Such data may relate to a plurality of configurations of mechanical components, joint position data, velocity data, acceleration data, torque data, force data, and power data, among other possibilities.

During teach mode the user may grasp onto the EOAS or wrist in some examples or onto any part of robotic arm in other examples, and provide an external force by physically moving robotic arm. In particular, the user may guide the robotic arm towards grasping onto an object and then moving the object from a first location to a second location. As the user guides the robotic arm during teach mode, the robot may obtain and record data related to the movement such that the robotic arm may be configured to independently carry out the task at a future time during independent operation (e.g., when the robotic arm operates independently outside of teach mode). In some examples, external forces may also be applied by other entities in the physical workspace such as by other objects, machines, or robotic systems, among other possibilities.

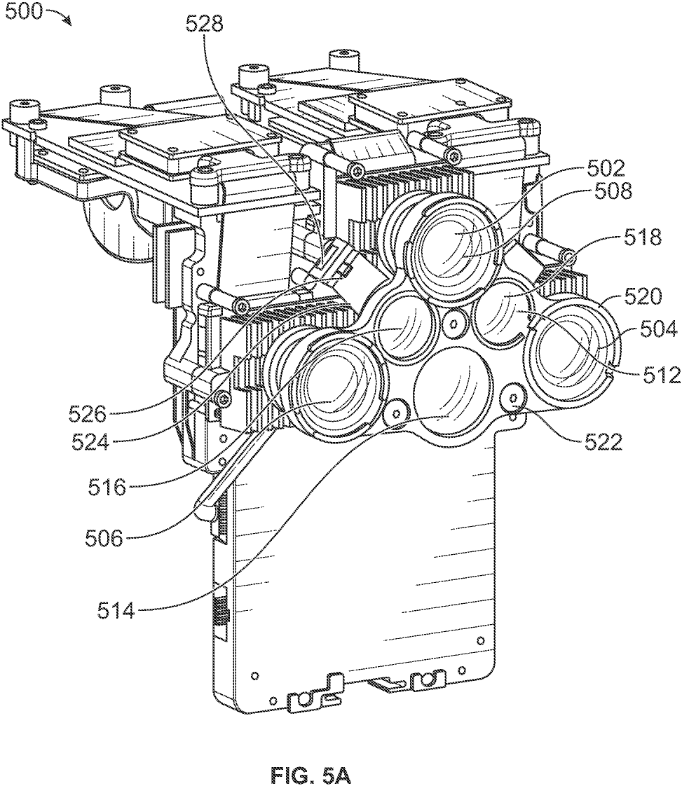

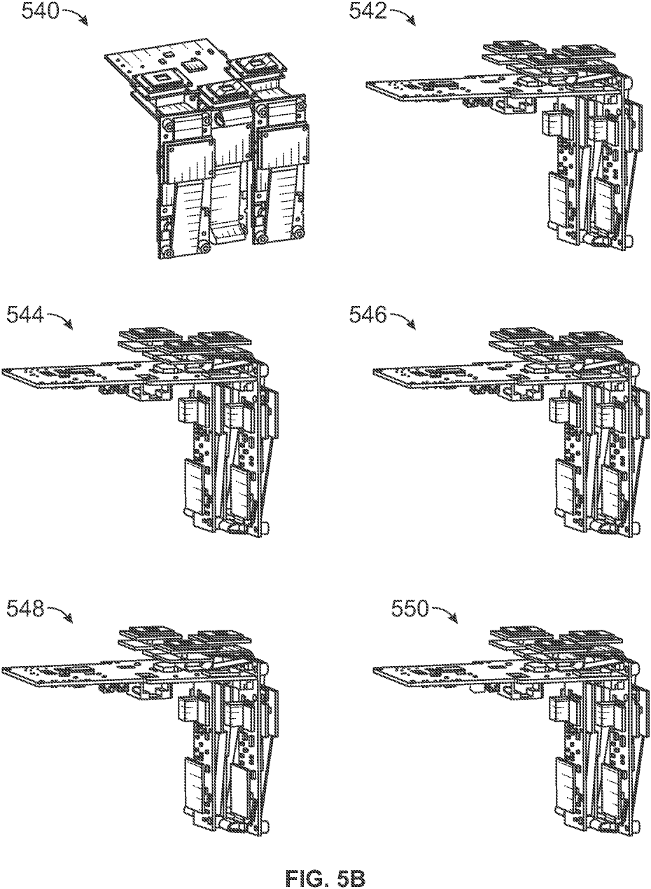

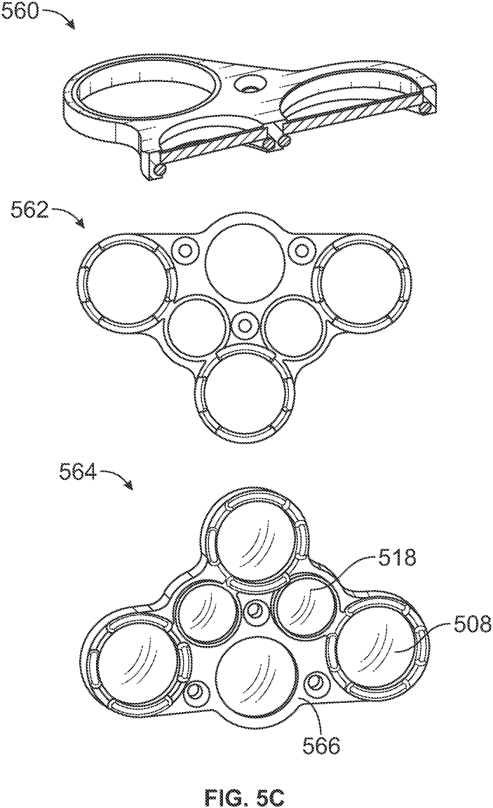

FIG. 5A depicts sensing device 500, in accordance with example embodiments. Sensing device 500 may include UV camera 502, camera 504, camera 506, camera windows 508, UV LED cluster 512, white LED cluster 514, UV LED cluster 516, LED diffusers 518, bezel subassembly 520, bezel mount screws 522, illumination PCBA 524, blue indicator LED 526, and UV disable switch 528.

As shown, the illumination sources (e.g., white LED cluster 514, UV LED cluster 512, and UV LED cluster 516) may be arranged in a v-shaped cluster with white LED cluster 514 forming the bottom of the “v” and UV LED clusters 512 and 516 forming the tip of the “v.” This formation may be symmetrical to a plane running through the central axis of white LED cluster 514. White LED cluster 514 may include four white LEDs, and UV LED clusters 512 and 516 may include a total of six UV LEDs (e.g., three UV LEDs per cluster).

Each of the LED clusters (e.g., white LED cluster 514, UV LED cluster 512, and UV LED cluster 516) may be covered by at least one optical diffuser 518, which may be used to to scatter the light from the illumination sources such that shadows are less apparent in sensor data illuminated with the illumination sources. More apparent shadows may make it more difficult for the robotic device to determine edges of an object and/or substance if the edge is covered by a harsh shadow. The illumination sources (e.g., white LED cluster 514, UV LED cluster 512, and UV LED cluster 516) may be mounted on illumination PCBA 524.

These illumination sources may be surrounded by cameras mounted on one or more PCBs. For instance, as shown in FIG. 5A, sensing device 500 includes UV camera 502 and cameras 504 and 506 surrounding white LED cluster 514, UV LED cluster 512, and UV LED cluster 516 such that UV camera 502, camera 504, camera 506, white LED cluster 514, UV LED cluster 512, and UV LED cluster 516 are arranged symmetrically with respect to a plane running through the optical axis of UV camera 502 and the central axis of white LED cluster 514. In some examples, UV camera 502 may include a UV filter to filter out light that is not within the UV spectrum, and UV camera 502 and cameras 504 and 506 may each be covered by camera windows 508.

FIG. 5B depicts diagrams 540, 542, 544, 546, 548, and 550, each of which depict an imaging subsystem, in accordance with example embodiments. Diagrams 540 and 542 may be two different perspectives of the imaging subsystem. Diagrams 544, 546, 548, and 550 highlight different components of the imaging subsystem. Namely, the imaging subsystem may include a main imaging PCBA (which may be indicated in blue by diagram 544), at least one ACP logic board (which may be indicated in blue by diagram 546), at least one flex extension (which may be indicated in blue by diagram 548), and three image sensor boards (which may be indicated in blue by diagram 550). These components may be stackable such that the main imaging PCBA may be connected to the logic boards, which may then be connected to the flex extensions, which may then be connected to the three image sensor boards. Each of the three imaging sensor boards may then be connected to a camera. The illumination subsystem (which may include the illumination sources) may then be mechanically and/or electrically connected to this stacked imaging subsystem.

Referring back to FIG. 5A, sensing device 500 may include bezel subassembly 520. Bezel subassembly 520 may include a plurality of glass camera windows (e.g., camera windows 508) corresponding to camera locations (e.g., where cameras 502, 504, and 506 are located), a plurality of ground glass diffusers (e.g., LED diffusers 518) corresponding to illumination locations (e.g., where white LED cluster 514, UV LED cluster 512, and UV LED cluster 516 are located), and a plurality of O-rings corresponding to the camera locations and the illumination cluster locations. In some examples, the ground glass diffusers may be manufactured using a certain type of glass that allows for good UV transmission. Bezel subassembly 520 may also include a mechanical bezel that surrounds glass windows 508 and LED diffusers 518. In some examples, the mechanical bezel may be 3D printed. Bezel subassembly 520 may be connected to the PCBAs, sensing device 500, and/or the robotic device through bezel mount screws 522.

FIG. 5C depicts components of sensing device 500, in accordance with example embodiments. Specifically, FIG. 5C includes diagrams 560, 562, and 564, each depicting bezel subassembly 520 and/or components of bezel subassembly 520 of sensing device 500. Namely, diagram 560 may be a cross section of bezel subassembly 520. The cross section of bezel subassembly 520 may include a cross section of various components in bezel subassembly 520, including the bezel and ground glass diffusers (e.g., LED diffusers 518). Diagram 562 depicts a bezel, which may be 3D printed and combined with other components to form bezel subassembly 520. Diagram 564 depicts a bezel subassembly, which may include glass camera windows 508 and ground glass diffusers 518, which may be surrounded by bezel 566. Ground glass diffusers 518 may be translucent and not fully transparent.

Referring back to FIG. 5A, sensing device 500 may include blue indicator LED 526 and UV disable switch 528. Blue indicator LED 526 may be used to indicate whether the UV LEDs are on, whether the white LED is on, and/or whether the cameras are on, among other possibilities. UV disable switch 528 may be used to completely disable UV LED clusters 512 and 516 such that the UV LED clusters may be re-enabled by switching UV disable switch 528. Additionally or alternatively, UV disable switch may be used to completely disable a camera with a UV filter (e.g., UV camera 502 with a UV filter) such that the camera may be re-enabled by switching UV disable switch 528.

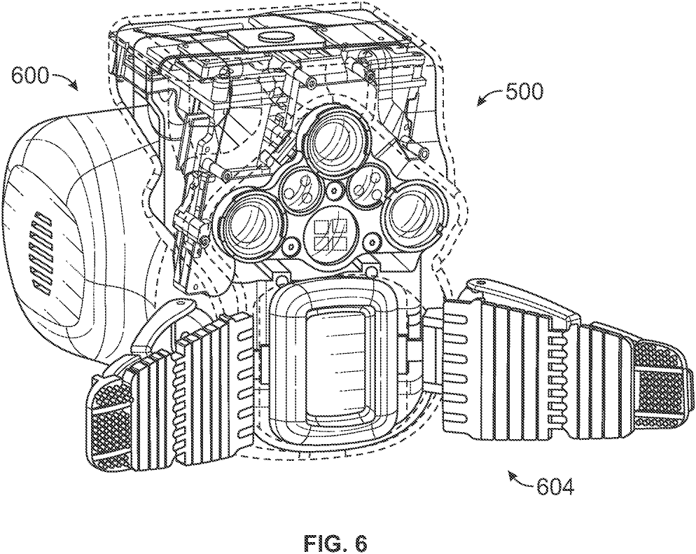

FIG. 6 is a sensor arrangement on an end of arm system, in accordance with example embodiments. Namely, sensing device 500 is attached to the end of arm system 600. End of arm system 600 may include a gripper 604 with opposable digits. In some examples, sensing device 500 may be placed proximate to gripper 604 such that at least a portion of the gripper 604 is in the field of view of sensing device 500 while the gripper 604 is operated. Gripper 604 being within the field of view of sensing device 500 may facilitate determining whether there is an object within gripper 604 and an approximate length, height, and/or size of the object within gripper 604.

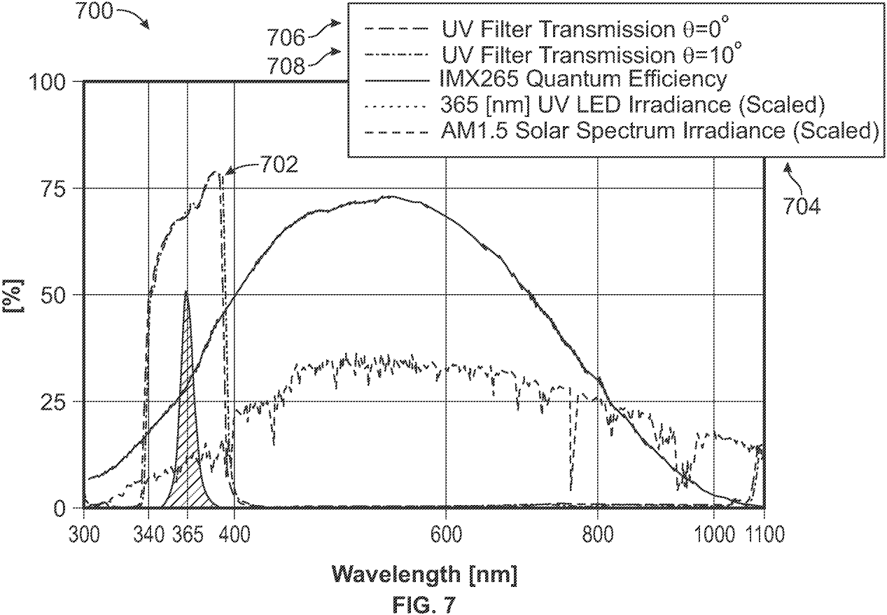

As mentioned above, sensing device 500 may include UV camera 502, which may be covered with a UV filter that allows light in the UV spectrum and blocks light in the visible and near infrared spectrums. FIG. 7 depicts plot 700 of transmitted light through an ultraviolet (UV) filter, in accordance with example embodiments. Plot 700 includes key 704, which indicates that UV filter transmissions are depicted by lines 706 and 708. As depicted in plot 700, lines 706 and 708 depict broad peak 702, indicating a high percentage of transmitted light at wavelengths that correspond to UV light. At all other wavelengths, lines 706 and 708 indicate lower amounts of light being transmitted, indicating that the UV filter blocks these wavelengths (namely wavelengths that correspond to the visible and near infrared spectrum).

The wavelengths that are transmitted by the UV filter may be equivalent at different angular ranges. For example, the UV filter that allows and blocks light according to plot 700 may have an angular range of up to +/- 10 degrees. Line 706 depicts the amount of light that is allowed through the filter at 0 degrees at various wavelengths. Line 708 depicts the amount of light that is allowed through the filter at 10 degrees at various wavelengths. Lines 706 and 708 may be approximately overlapping, resulting in the amount of light at different wavelengths that is allowed through the filter and/or blocked by the filter to be equivalent at different angles. UV filters having similar transmissions throughout the UV filter’s angular range may be important to ensure that the amount of light being allowed through the filter and/or blocked out is consistent (e.g., so that other wavelengths of light entering at various angular ranges are not interfering with the UV sensor data being collected).

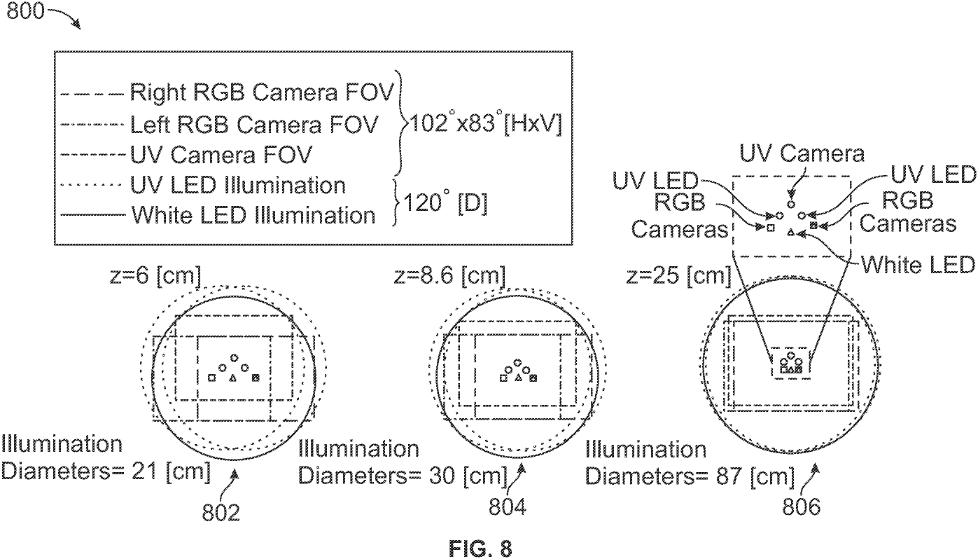

FIG. 8 depicts fields of views 802, 804, and 806 of components on the sensor arrangement at various distances, in accordance with example embodiments. Fields of views 802 depicts the fields of views of the cameras and illumination sources on sensing device 500 when sensing device 500 is at a first distance from a surface. Fields of views 804 depicts the fields of views of the cameras and illumination sources on sensing device 500 when the cameras and illumination sources are at a second distance farther from the surface (e.g., compared to fields of views 802). And fields of views 806 depicts the fields of views of the cameras and illumination sources on sensing device 500 when the cameras and illumination sources are at a third distance even farther from the surface (e.g., compared to fields of views 802 and 804).

As sensing device 500 moves farther from the surface, the areas covered by the fields of views expand and increasingly overlap with each other. Sensor data obtained farther from the surface may be more consistent across cameras. For example, the cameras may each capture all or most of the area illuminated by each illumination source when the sensing device 500 is farther from the surface being captured, as depicted in fields of views 806. In contrast, when sensing device 500 is closer to the surface being captured, the captured sensor data may be more different across cameras. For example, the cameras may each no longer be able to capture all or most of the areas illuminated by each illumination source. The right RGB camera and the left RGB camera may capture areas illuminated by one UV LED source and areas illuminated by another UV LED source. Based on the different fields of view, the right RGB camera may capture more light on the left side of an image and the left RGB camera may capture more light on the right side of an image where the illumination sources overlap. Although the surface being captured may be clearer when sensing device 500 is closer to the surface, the slight inconsistencies in lighting may result in difficulties detecting materials and/or substances because certain areas may be more exposed with light than other areas. Accordingly, it may be advantageous to couple a sensing device to a moveable component of a robot to allow for capturing of sensor data at multiple distances and/or angles.

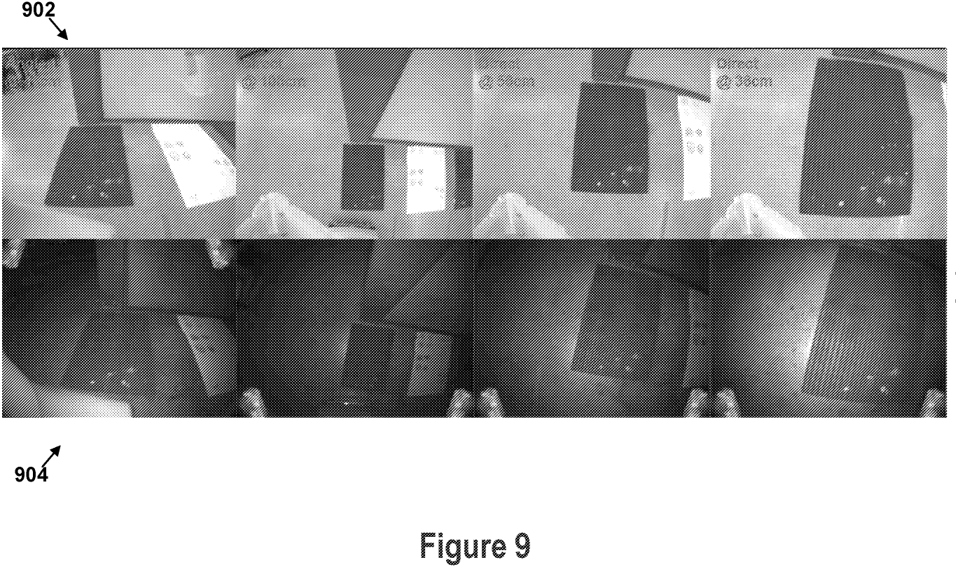

FIG. 9 illustrates images taken with a sensor arrangement, in accordance with example embodiments. FIG. 9 includes visible light camera data 902 and UV light camera data 904. Visible light camera data 902 and UV light camera data 904 depict various substances (e.g., dry coke, wet coke, wet sauces, dry sauces, dry light tea, wet light tea, wet beer, dry beer, dry coffee, wet coffee, wet coconut water, dry coconut water, dry coffee with milk, wet coffee with milk, dry dark tea, wet dark tea, dry water, wet water, salt, pepper, cookies/chips crust, yogurt, sugar, and/or oil) spread in a matrix format on a soft carpet surface. Different substances are visible, somewhat visible, and not visible according to which camera was used to collect the data.

For example, in visible light camera data 902, about five groups are visible (corresponding to cookies/chips crust, yogurt, salt, pepper, and sugar), none are somewhat visible, and ten groups are not visible (corresponding to coke, light tea, coffee, coffee with milk, sauces, beer, coconut water, water, dark tea, and oil). In contrast, from UV light camera data 904, about eight groups are visible (corresponding to cookies/chips crust, yogurt, sugar, salt, coffee, coffee with milk, and dark tea), two groups are somewhat visible (corresponding to beer and pepper), and six groups are not visible (corresponding to coke, light tea, sauces, coconut water, water, and oil).

Having multiple types of sensors may facilitate detection of a broader set of substances, because certain substances may be more visible in visible light data as opposed to UV light and vice versa. In the case of visible light camera data 902 and UV light camera data 904, cookies/chips crust, yogurt, salt, and sugar may be fairly visible on both. Pepper may only be visible in visible light camera data 902 and somewhat visible in UV light camera data 904. Coffee, coffee with milk, and dark tea may be visible in UV light camera data 904, but not visible in visible light camera data 902. Thus, by collecting sensor data in both spectrums, the robotic device may be able to detect several more groups of data than it otherwise would.

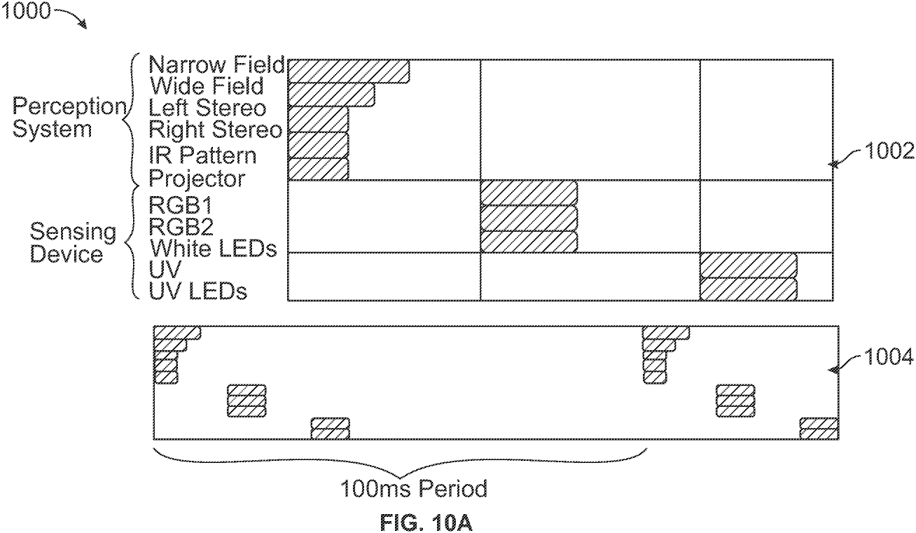

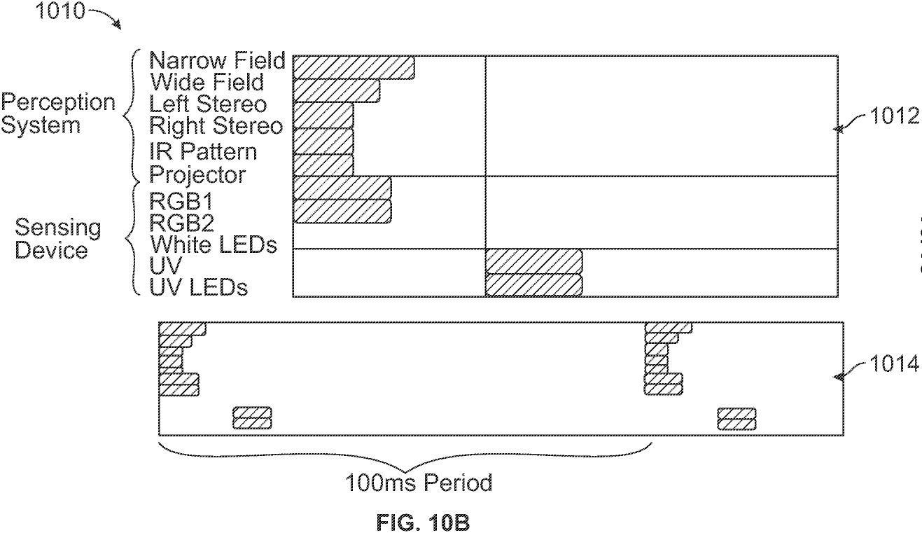

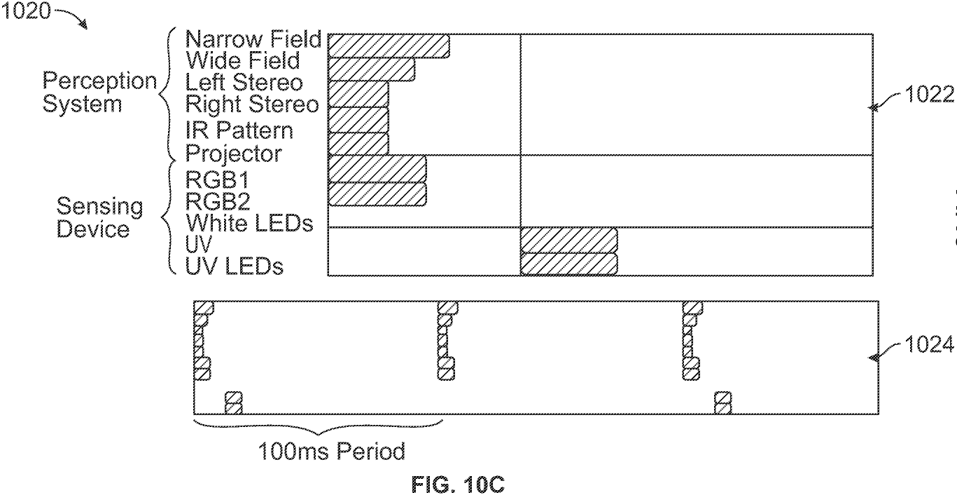

FIG. 10A depicts exposure schedule 1000, in accordance with example embodiments. In addition, FIG. 10B depicts exposure schedule 1010, in accordance with example embodiments. Further, FIG. 10C depicts exposure schedule 1020, in accordance with example embodiments. Exposure schedules 1000, 1010, and 1020 depict when sensors may and illumination sources may be enabled and/or disabled to avoid illumination crosstalk. Exposure schedules 1000, 1010, and 1020 may apply to a robotic device with a perception system and a sensing device. The perception system of this robotic device may include a narrow field of view sensor, a wide field of view sensor, cameras arranged in a left stereo pair, cameras arranged in a right stereo pair, and an infrared (IR) pattern projector. The sensing device may include a first camera capable of capturing RGB sensor data in the visible light spectrum, a second camera capable of capturing RGB sensor data in the visible light spectrum, white LEDs, a UV camera capable of capturing data in the UV spectrum (e.g., a camera with the UV filter described above), and UV LEDs.

In some examples, the robotic device may follow exposure schedule 1000. Exposure schedule 1000 may be periodic, and single cycle chart 1002 may depict exposure schedule 1000 for a single period, and multi cycle chart 1004 may depict exposure schedule 1000 for multiple periods. The robotic device may enable all the sensors and illumination sources of the perception system and disable all the sensors and illumination sources of the sensing device. The robotic device may then disable all the sensors and illumination sources for a length of time, before enabling all the sensors and illumination sources of the sensing device that are associated with the visible light spectrum (e.g., the first camera capable of capturing RGB sensor data in the visible light spectrum, the second camera capable of capturing RGB sensor data in the visible light spectrum, and the white LEDs). Subsequently, the robotic device may disable all the sensors and illumination sources for a length of time, before enabling all the sensors and illumination sources of the sensing device that are associated with the UV light spectrum (e.g., the UV camera capable of capturing data in the UV spectrum and the UV LEDs). This cycle may be repeated periodically (e.g., every 100 ms as depicted by multi cycle chart 1004).

Additionally or alternatively, the robotic device may follow exposure schedule 1010, which may be periodic. Single cycle chart 1012 may depict exposure schedule 1010 for a single period, and multi cycle chart 1014 may depict exposure schedule 1010 for multiple periods. Exposure schedule 1010 may have a shorter time interval between the perception system exposure and the UV camera exposure . Namely, exposure schedule 1010 may enable the visible light sensors of the sensing device (e.g., first camera capable of capturing RGB sensor data in the visible light spectrum and the second camera capable of capturing RGB sensor data in the visible light spectrum) without enabling the white light LEDs of the sensing system. These visible light sensors of the sensing device may be enabled with the sensors and illumination sources of the perception system such that perception system sensor data and sensing device sensor data may be collected simultaneously using illumination from the perception system and/or the surroundings. Subsequently, all the sensors and illumination sources may be disabled for a period of time before the sensors and illumination sources of the sensing device that are associated with the UV light spectrum (e.g., the UV camera capable of capturing data in the UV spectrum and the UV LEDs) are enabled. Exposure schedule 1010 may allow for lower latency in accumulating a whole-robot snapshot.

In some examples, each group of sensors and illumination sources being enabled and/or disabled may be enabled and/or disabled at different frequencies. For example, the robotic device may follow exposure schedule 1020, which, for a single period, may have a similar enable/disable pattern as exposure schedule 1010. Single cycle chart 1022 may depict exposure schedule 1020 for a single period, and multi cycle chart 1024 may depict exposure schedule 1020 for multiple periods. As depicted by multi cycle chart 1024, the the sensors and illumination sources of the sensing device that are associated with the UV light spectrum (e.g., the UV camera capable of capturing data in the UV spectrum and the UV LEDs) are enabled less frequently than the sensors and illumination sources on the perception system and the visible light sensors of the sensing device (e.g., first camera capable of capturing RGB sensor data in the visible light spectrum and the second camera capable of capturing RGB data in the visible light spectrum).

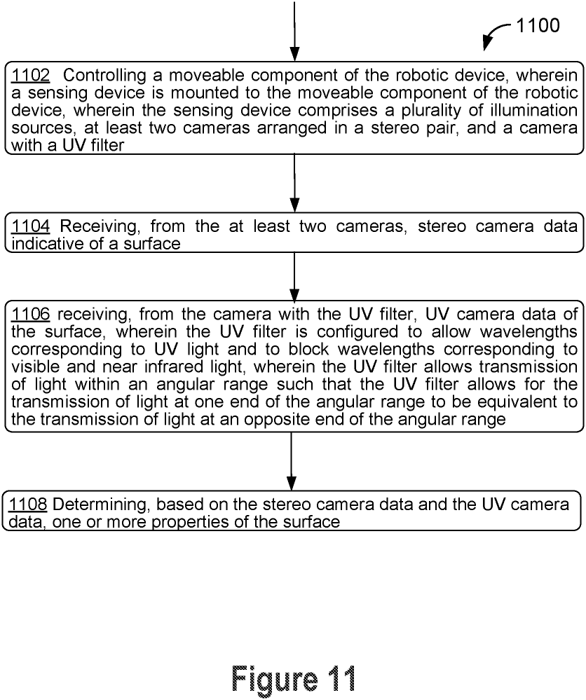

FIG. 11 is a block diagram of a method, in accordance with example embodiments. In some examples, method 1100 of FIG. 11 may be carried out by a control system, such as control system 118 of robotic system 100. In further examples, method 1100 may be carried out by one or more processors, such as processor(s) 102, executing program instructions, such as program instructions 106, stored in a data storage, such as data storage 104. Execution of method 1100 may involve a robotic device, such as the robotic device illustrated and described with respect to FIGS. 1-4, integrated with sensor systems and/or processing methods illustrated by FIGS. 5-10. Other robotic devices may also be used in the performance of method 1100. In further examples, some or all of the blocks of method 1100 may be performed by a control system remote from the robotic device. In yet further examples, different blocks of method 1100 may be performed by different control systems, located on and/or remote from a robotic device.

At block 1102, method 1100 includes controlling a moveable component of the robotic device, wherein a sensing device is mounted to the moveable component of the robotic device, wherein the sensing device comprises a plurality of illumination sources, at least two cameras arranged in a stereo pair, and a camera with a UV filter.

At block 1104, method 1100 includes receiving, from the at least two cameras, stereo camera data indicative of a surface.

At block 1106, method 1100 includes receiving, from the camera with the UV filter, UV camera data of the surface, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range.

At block 1108, method 1100 includes determining, based on the stereo camera data and the UV camera data, one or more properties of the surface.

In some examples, the robotic device includes a perception system. Method 1100 includes disabling the plurality of illumination sources and while the plurality of illumination sources are disabled, receiving, from the perception system, perception system sensor data.

In some examples, the plurality of illumination sources comprise a white LED cluster and two UV LED clusters. Method 1100 includes, before receiving the stereo camera data, disabling the two UV LED clusters, wherein receiving the stereo camera data indicative of the surface is performed while the two UV LED clusters are disabled.

In some examples, the plurality of illumination sources comprise a white LED cluster and two UV LED clusters. Method 1100 includes, before receiving the UV camera data, disabling the white LED cluster, wherein receiving the UV camera data of the surface is performed while the white LED cluster is disabled.

In some examples, a sensing device for mounting on a movable component of a robotic device is provided. The sensing device comprises a plurality of illumination sources comprising at least one ultraviolet (UV) illumination source, at least two cameras arranged in a stereo pair, and a camera with a UV filter, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range.

In some examples, the moveable component of the robotic device is an end of the arm system of the robotic device.

In some examples, the end of arm system includes a gripper, wherein the sensing device is mounted adjacent to the gripper.

In some examples, at least a portion of the gripper is within the field of view of one or more cameras of the sensing device.

In some examples, the sensing device further comprises a plurality of diffusers covering each of the illumination sources.

In some examples, the sensing device further comprises a bezel subassembly comprising: a plurality of glass camera windows corresponding to camera locations where the at least two cameras and the camera with the UV filter are located and a plurality of ground glass diffusers corresponding to illumination locations where the plurality of illumination sources are located.

In some examples, the bezel subassembly further comprises a plurality of O-rings corresponding to the camera locations and the illumination locations, wherein the plurality of glass camera windows and the plurality of ground glass diffusers are surrounded by a bezel.

In some examples, the plurality of illumination sources are arranged in a cluster and wherein the at least two cameras arranged in the stereo pair and the camera with the UV filter are arranged around the plurality of illumination sources.

In some examples, the plurality of illumination sources comprise a white light emitting diode (LED) cluster and two UV LED clusters.

In some examples, the sensing device comprises an illumination printed circuit board (PCB) on which the plurality of illumination sources are mounted, at least one camera PCB on which the at least two cameras in the stereo pair and the camera with the UV filter are mounted, and at least one intermediate PCB connecting the illumination PCB and the at least one camera PCB.

In some examples, the at least two cameras and the two UV LED clusters are arranged symmetrically with respect to a plane running through the optical axis of the camera with the UV filter and the central axis of the white LED cluster.

In some examples, the at least two cameras are coated by a near infrared block filter coating that blocks wavelengths corresponding to near infrared light. In some examples, the at least two cameras may be covered by a near infrared block filter that blocks wavelengths corresponding to near infrared light.

In some examples, each camera of the at least two cameras and the camera with the UV filter has a negative distortion.

In some examples, the sensing device further comprises a fan mounted in proximity to the plurality of illumination sources, the at least two cameras, and the camera with the UV filter.

In some examples, a robotic device is provided. The robotic device comprises a movable component and a sensing device mounted on the movable component. The sensing device includes a plurality of illumination sources comprising at least one ultraviolet (UV) illumination source, at least two cameras arranged in a stereo pair, and a camera with a UV filter, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range.

### III. Conclusion

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software or hardware modules in the same physical device. However, other information transmissions may be between software modules or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A sensing device for mounting on a movable component of a robotic device, wherein the sensing device comprises:
a plurality of illumination sources comprising at least one ultraviolet (UV) illumination source;
at least two cameras arranged in a stereo pair; and
a camera with a UV filter, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range.

2. The sensing device of claim 1, wherein the movable component of the robotic device is an end of arm system of the robotic device.

3. The sensing device of claim 2, wherein the end of arm system includes a gripper, wherein the sensing device is mounted adjacent to the gripper.

4. The sensing device of claim 3, wherein at least a portion of the gripper is within the field of view of one or more cameras of the sensing device.

5. The sensing device of claim 1, further comprising a plurality of diffusers covering each of the illumination sources.

6. The sensing device of claim 1, further comprising:
a bezel subassembly comprising:
a plurality of glass camera windows corresponding to camera locations where the at least two cameras and the camera with the UV filter are located, and
a plurality of ground glass diffusers corresponding to illumination locations where the plurality of illumination sources are located, and.

7. The sensing device of claim 6, wherein the bezel subassembly further comprises:
a plurality of O-rings corresponding to the camera locations and the illumination locations, wherein the plurality of glass camera windows and the plurality of ground glass diffusers are surrounded by a bezel.

8. The sensing device of claim 1, wherein the plurality of illumination sources are arranged in a cluster and wherein the at least two cameras arranged in the stereo pair and the camera with the UV filter are arranged around the plurality of illumination sources.

9. The sensing device of claim 1, wherein the plurality of illumination sources comprise a white light emitting diode (LED) cluster and two UV LED clusters.

10. The sensing device of claim 9, wherein the at least two cameras and the two UV LED clusters are arranged symmetrically with respect to a plane running through the optical axis of the camera with the UV filter and central axis of the white LED cluster.

11. The sensing device of claim 1, further comprising:
an illumination printed circuit board (PCB) on which the plurality of illumination sources are mounted;
at least one camera PCB on which the at least two cameras in the stereo pair and the camera with the UV filter are mounted; and
at least one intermediate PCB connecting the illumination PCB and the at least one camera PCB.

12. The sensing device of claim 1, wherein the at least two cameras are coated by a near infrared block filter that blocks wavelengths corresponding to near infrared light.

13. The sensing device of claim 1, wherein each camera of the at least two cameras and the camera with the UV filter has a negative distortion.

14. The sensing device of claim 1 further comprising a fan mounted in proximity to the plurality of illumination sources, the at least two cameras, and the camera with the UV filter.

15. A robotic device comprising:
a movable component;
a sensing device mounted on the movable component, wherein the sensing device comprises:
a plurality of illumination sources comprising at least one ultraviolet (UV) illumination source;
at least two cameras arranged in a stereo pair; and
a camera with a UV filter, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range.

16. The robotic device of claim 15, wherein the plurality of illumination sources comprise a white light emitting diode (LED) cluster and two UV LED clusters.

17. A method comprising:
controlling a moveable component of the robotic device, wherein a sensing device is mounted to the moveable component of the robotic device, wherein the sensing device comprises a plurality of illumination sources, at least two cameras arranged in a stereo pair, and a camera with a UV filter;
receiving, from the at least two cameras, stereo camera data indicative of a surface;
receiving, from the camera with the UV filter, UV camera data of the surface, wherein the UV filter is configured to allow wavelengths corresponding to UV light and to block wavelengths corresponding to visible and near infrared light, wherein the UV filter allows transmission of light within an angular range such that the UV filter allows for the transmission of light at one end of the angular range to be equivalent to the transmission of light at an opposite end of the angular range; and
determining, based on the stereo camera data and the UV camera data, one or more properties of the surface.

18. The method of claim 17, wherein the robotic device further comprises a perception system, wherein method further comprises:
disabling the plurality of illumination sources; and
while the plurality of illumination sources are disabled, receiving, from the perception system, perception system sensor data.

19. The method of claim 17, wherein the plurality of illumination sources comprise a white LED cluster and two UV LED clusters, wherein the method further comprises:
before receiving the stereo camera data, disabling the two UV LED clusters, wherein receiving the stereo camera data indicative of the surface is performed while the two UV LED clusters are disabled.

20. The method of claim 17, wherein the plurality of illumination sources comprise a white LED cluster and two UV LED clusters, wherein the method further comprises:
before receiving the UV camera data, disabling the white LED cluster, wherein receiving the UV camera data of the surface is performed while the white LED cluster is disabled.
